(19) United States
(12) Patent Application Publication
(10) Pub. No.: US 2026/0359198 A1
(43) Pub. Date: Nov. 12, 2026

(54) METHOD FOR MONITORING INTERFACES BETWEEN A SOFTWARE APPLICATION AND A CONTROL UNIT

(71) Applicant: Robert Bosch GmbH, Stuttgart (DE)

(72) Inventors: Oliver Kust, Stuttgart (DE); Cyrille Wiederkehr, Souffelweyersheim (FR); Marco Andreas Wagner, Talheim (DE)

(21) Appl. No.: 19/125,507

(22) PCT Filed: Nov. 7, 2023
(86) PCT No.: PCT/EP2023/080928

§ 371 Date: Jul. 21, 2025

(30) Foreign Application Priority Data
Nov. 7, 2022 (DE) 10 2022 211 725.5

(51) Int. Cl. G06F 11/3668

(52) U.S. Cl. CPC G06F 11/3672

(57) ABSTRACT

A method for monitoring interfaces between a software application and a control unit. The control unit controls an output apparatus. A service request and/or target value sent from the software application to the control unit is checked on based on rules by a monitoring apparatus which is disposed such that the service request and/or target value can first be sent to the monitoring apparatus and from there to the control unit, and the service request and/or target value is sent from the monitoring apparatus to the control unit only if the check by the monitoring apparatus shows that the service request and/or target value is permissible. An apparatus, a computer program, and an electronic storage medium, are also described.

### BACKGROUND INFORMATION

Electronic control and regulation systems, such as those used in machines, vehicles, and devices, typically consist of input devices such as sensors or operating elements, a control or regulation logic and output apparatuses such as actuators or displays. In electronically programmable systems, the logic is usually represented by software applications that are executed as functional software on computing devices and should be distinguished from the basic software of the computing devices.

Software applications can run on a single control unit or be distributed across a network of control units (E/E architecture), such as those used in vehicles, and communicate with one another via communication systems such as data buses.

A variety of methods for identifying malfunctions in output apparatuses are described in the related art. U.S. Patent Application Publication No. US 2003/0093727 A1 describes a bus monitor unit on a central node of a data bus system, which, in the event of a faulty communication with respect to defined time patterns on the data bus, can at least temporarily block the participant causing the faulty communication from communicating on the data bus, or compensate the faulty communication triggered by interference.

European Patent No. EP 3 437 261 B1 describes an apparatus for filtering the data transfer of safety-relevant interventions from one communication unit to another with a control unit. The filtering is based on parameters from another communication unit and can lead to a complete interruption or partial filtering of the data transfer.

When assigning software applications to electronic computing devices, the computing device and the application have to have an appropriate level of safety integrity. Modern E/E architectures use computing devices and software applications with varying levels of safety integrity. Software applications with no or low safety integrity accessing control units with output apparatuses with higher safety integrity requires the use of additional measures or monitoring apparatuses. This is necessary in the following cases, for example:
Software applications for which there is no proof that they have been developed according to a safety standard, e.g. so-called “legacy code”, “off-the-shelf” products.
Software applications that themselves are not safety-relevant and therefore have not been developed according to any safety standard but access safety-relevant output apparatuses and therefore do not possess safety integrity within the meaning of the safety standards or are considered “untrusted”.
When deliberately separating software applications into “trusted” and “untrusted” (sub) functions, in order to take the safety burden from “untrusted” functions and be able to develop them with less effort. This can also include distinguishing between homologation-relevant and non-homologation-relevant software applications.
The relocation of a software application or parts of a software application to new E/E architectures.

Devices for monitoring application interfaces are intended to ensure that, in all operating situations of the system, for example a vehicle, data via interfaces from untrusted software applications do not lead to malfunctions by an output apparatus.

### SUMMARY

A method according to the present invention for monitoring interfaces between a software application and a control unit, wherein the control unit controls an output apparatus, has the advantage that a service request and/or target value sent from the software application to the control unit is checked on the basis of rules by a monitoring apparatus which is disposed such that the service request and/or target value can first be sent to the monitoring apparatus and from there to the control unit, and the service request and/or target value is sent from the monitoring apparatus to the control unit only if the check by the monitoring apparatus shows that the service request and/or target value is permissible.

In an application of the method according to the present invention to a wiper control of a vehicle, for example, the rules can be a specification for a permissible angular position of a wiper. In this case, for example, it can be specified that a specific angular position can only be approached if the hood of the vehicle is closed (“hood closed”) and there is also a signal that indicates that the wiper is not in wiping operation (“wiper off”). The method according to the present invention is preferably used in motor vehicles, for example in the wiper control of motor vehicles.

In other words, according to an example embodiment of the present invention, the monitoring apparatus is disposed such that there is a communication link between the software application and the monitoring apparatus and also a communication link between the monitoring apparatus and the control unit, so that, as long as the monitoring apparatus is not blocking the forwarding of the service request and/or target value, a service request and/or target value is routed from the software application via the monitoring apparatus to the control unit. In an advantageous configuration, the monitoring apparatus is disposed such that, since there is no alternative communication link between the software application and the control unit that bypasses the monitoring apparatus, a service request and/or target value to be sent from the software application to the control unit has to be routed via the monitoring apparatus.

The monitoring apparatus can be implemented in hardware, software, or a combination of hardware and software.

A service request can, for instance, be understood to be a control of the output apparatus that describes an effect to be achieved, but does not define a specific control signal for the output apparatus, so that the specific control signal is created by the control unit using the service request. An example of a service request in the context of a vehicle can therefore be the request “rear fog light on”. Another example of a service request is the request to move the wiper of a vehicle to a specific angular position.

A target value can be understood to be a specification of a value that should be set by the output apparatus, in particular an actuator, for example. An example of a target value in the context of a vehicle can therefore be the specification of a torque to be generated on an electric machine.

According to an example embodiment of the present invention, the output apparatus can in particular be an actuator, in particular an actuator of a vehicle, in particular a wiper motor, and/or a display device and/or an output apparatus for outputting information, such as a display.

According to an example embodiment of the present invention, it is advantageous when the check by the monitoring apparatus is additionally carried out as a function of modes. In an application of the method according to the present invention in a vehicle, the modes can be the modes “driving”, “parking” and “stationary”, for example. In an advantageous further development, the modes can then be derived from state variables such as “parking position”, for example provided by a transmission control unit, “vehicle speed”, or “engine speed”.

According to an example embodiment of the present invention, it is also advantageous that the monitoring apparatus comprises a state machine that forms the modes based on input variables and/or state variables. The modes can alternatively be formed directly via input variables and/or state variables that are fed to the monitoring apparatus. State variables can in particular be variables that describe the state of a technical system, for example of a vehicle. The state of the technical system can in particular be an operating state. Examples of state variables when using the method according to the present invention in a vehicle are, among other things, information about the “hood closed” state or the speed of the vehicle.

According to an example embodiment of the present invention, the input variables can in particular be variables entered via an input unit, in particular a human-machine interface, for example a wiper control specified via a steering column lever, such as a selection of the “intermittent wiping” mode by a corresponding position of the steering column lever. Alternatively or additionally, however, the input variables can also be from other control units, for example when using the method according to the present invention in a vehicle. This can, for instance, be a rain sensor that sends an input variable “wiper on” or “wiper level 1” or “intermittent wiping”.

According to an example embodiment of the present invention, it is advantageous that the monitoring apparatus additionally carries out a prioritization of a plurality of service requests and/or target values that the software application sends to the control unit, in particular when every service request and/or target value sent by the software application to the control unit is checked by the monitoring apparatus. Additional prioritization allows the functionality of the monitoring apparatus to be used effectively without the need for a further module. This advantageously also allows safety-relevant software applications and non-safety-relevant applications to access the same output unit, for example the same actuator, in which case the safety-relevant software application is given higher priority than the non-safety-relevant software application. This makes it possible to further increase the safety of the system, for example of a vehicle.

Advantageously included according to an example embodiment of the present invention are also an apparatus and a computer program configured to implement the method according to the present invention, as well as a storage medium that comprises the computer program.

An embodiment example of the present invention as used in a vehicle, in particular in connection with a wiper control, is explained in more detail in the following with reference to the figures.

### BRIEF DESCRIPTION OF THE DRAWINGS

FIG. 1 shows a schematic illustration of a monitoring of service requests and/or target values by a monitoring apparatus according to a first embodiment example of the method according to the present invention

FIG. 2 shows a schematic illustration of a monitoring of service requests and/or target values by a monitoring apparatus comprising a prioritization according to a second embodiment of the method according to the present invention;

FIG. 3 shows a schematic illustration of a monitoring apparatus according to a further embodiment example of the present invention.

FIGS. 4A and 6B show preferred arrangements of the monitoring apparatus, according to example embodiments of the present invention.

### DETAILED DESCRIPTION OF EXAMPLE EMBODIMENTS

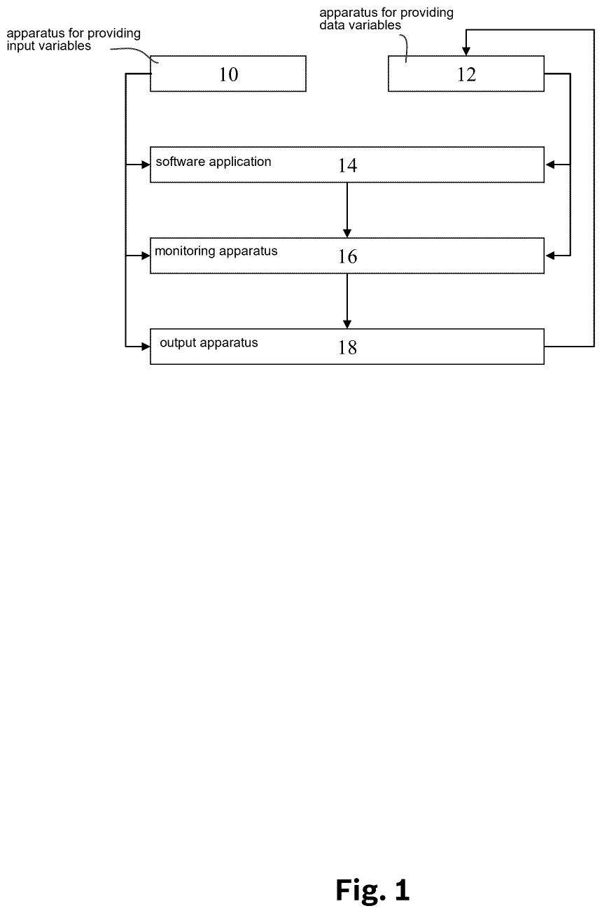

FIG. 1 shows a schematic illustration of a monitoring of service requests and/or target values by a monitoring apparatus (16) according to an embodiment example of the method according to the present invention. An untrusted software application (14) sends a service request and/or target value to the monitoring apparatus (16), where the service request and/or target value is checked based on rules and modes. If the service request and/or target value is permissible, the service request and/or target value is forwarded to a control unit with an output apparatus (18), where the service request and/or target value is implemented. An apparatus for providing input variables (10), for example a steering column lever, sends input variables, for example a position of a steering column lever for controlling a wiper, to the software application (14), the monitoring apparatus (16) and the control unit with the output apparatus (18). An apparatus for providing state variables (12) sends state variables, for example the state variables “standstill”, “driving” and/or “parking” to the software application (14) and the monitoring apparatus (16). The control unit with the output apparatus (18) can send information to the apparatus for providing state variables (12), which can be used there to create further or updated state variables.

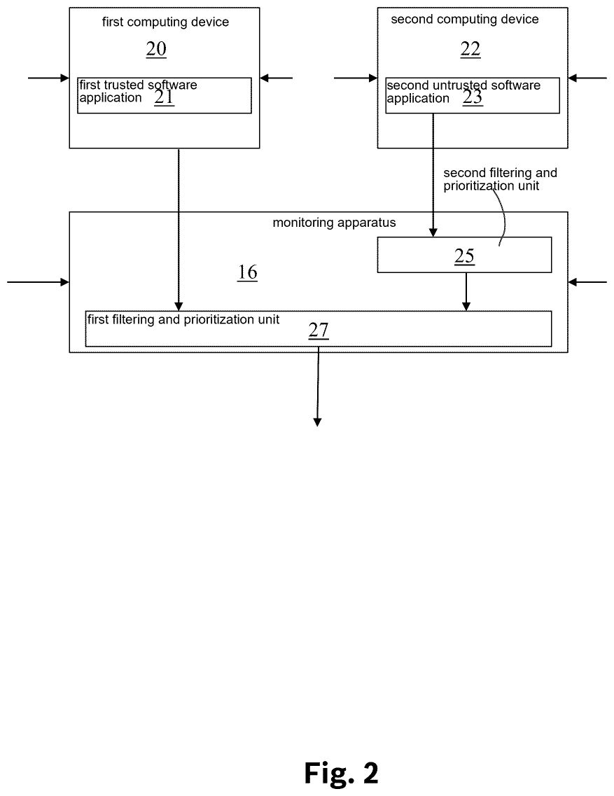

FIG. 2 shows a schematic illustration of a monitoring of service requests and/or target values by a monitoring apparatus (16) comprising a prioritization according to a second embodiment of the method according to the present invention. A first, trusted software application (21), which is being executed on a first computing device (20) that is classified as trusted, sends service requests and/or target values to the monitoring apparatus (16). A second, untrusted software application (23), which is being executed on a second computing device (22) that is classified as untrusted, sends service requests and/or target values to the monitoring apparatus (16). The first software application (21), the second software application (23) and the monitoring apparatus (16) each receive input variables and state variables (symbolized by the respective arrows). The monitoring apparatus (16) includes a first filtering and prioritization unit (27), to which the service requests and/or target values of the first software application (21) are fed, and a second filtering and prioritization unit (25), to which the service requests and/or target values of the second software application (23) are fed. The service requests and/or target values filtered and prioritized by the second filtering and prioritization unit are likewise fed to the first filtering and prioritization unit (27), so that the first filtering and prioritization unit (27) filters and prioritizes the service requests and/or target values filtered and prioritized by the second filtering and prioritization unit (25) and the service requests and/or target values sent by the first software application (21).

Service requests and/or target values of the first software application (21) are therefore filtered by the monitoring apparatus (16) only once, whereas the service requests and/or target values of the (untrusted) second software application are filtered and prioritized twice. Due to the hierarchical prioritization, the service requests and/or target values of the first software application (21) can always be given a higher priority than the service requests and/or target values of the second software application (23). The first filtering and prioritization unit (27) provides filtered and prioritized service requests and/or target values that can be further processed outside the monitoring apparatus (16) or forwarded to control units as described in connection with FIG. 1.

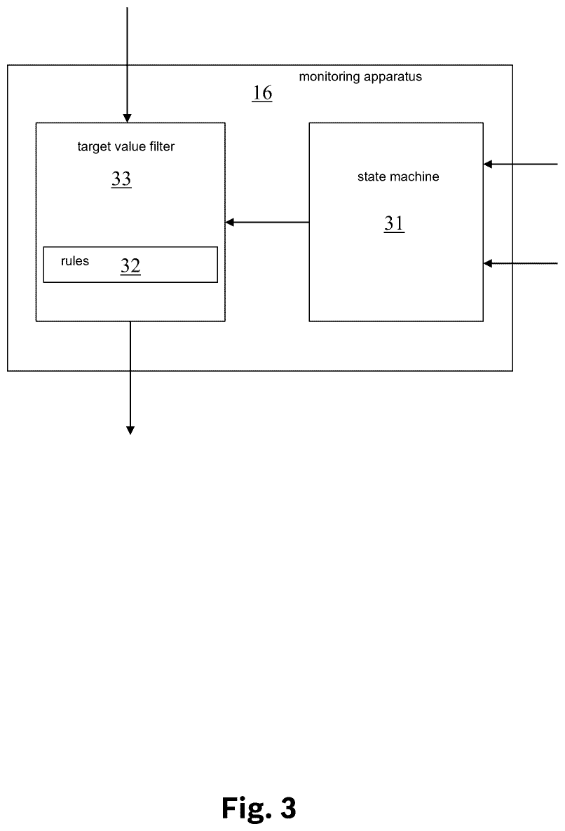

FIG. 3 shows a schematic illustration of a monitoring apparatus (16) according to a further embodiment example. The monitoring apparatuses as described in connection with FIG. 1 and FIG. 2 can in particular be the monitoring apparatus (16) of FIG. 3.

The monitoring apparatus (16) comprises a state machine (31), to which input variables and state variables are fed, and a target value filter (33), which in turn comprises rules (32) for filtering service requests and/or target values. The state machine (31) is configured to create modes based on the input variables and state variables and forward them to the target value filter (33). The rules (32) are created using the modes.

The rules and modes are used to filter service requests and/or target values that are sent to the target value filter (33) of the monitoring apparatus (16). The filtered (and possibly prioritized) service requests and/or target values are output by the monitoring apparatus (16).

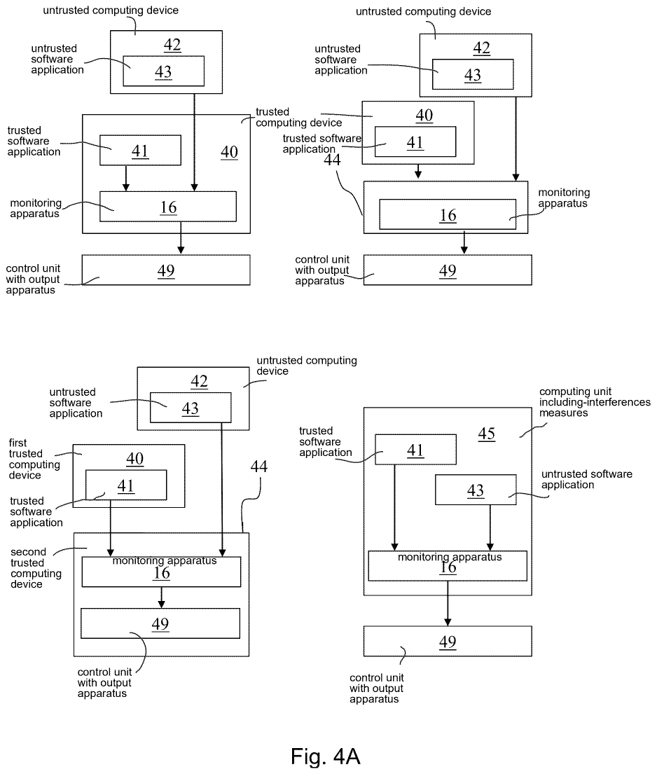

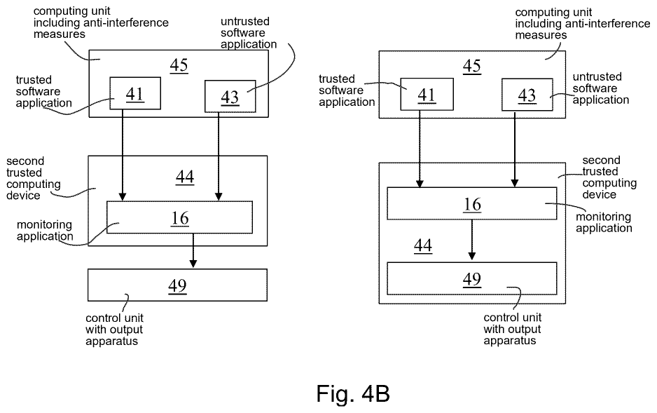

FIGS. 4A and 4B show six preferred arrangements of the monitoring apparatus divided into subfigures FIG. 4A and FIG. 4B. Parts having the same functionality are labeled in the six preferred arrangements with the same reference signs. These are:
a monitoring apparatus (16) as described in connection with FIGS. 1 to 3,
a first trusted computing device (40),
a trusted software application (41) which is being executed on the trusted computing device (40),
an untrusted computing device (42),
an untrusted software application (43) which is being executed on the untrusted computing device (42),
a control unit with an output apparatus (49),
a second trusted computing device (44) on which no software application is being executed, and
a computing device comprising anti-interference measures (45) on which a plurality of software applications are being executed. The anti-interference measures in particular enable the execution of a plurality of software applications without the execution of one software application having an effect on the flow or the results of the other Software application.

The control unit with the output apparatus (49) and the monitoring apparatus (16) can in particular be implemented in hardware, software or a combination of hardware and software.

FIG. 4A shows a first arrangement (top left) of the monitoring apparatus (16) which is integrated into the first trusted computing device (40). The trusted software application (41) is being executed on the first trusted computing device (40). The untrusted software application (43) is being executed on the untrusted computing device (42). Service requests and/or target values of the trusted software application (41) and the untrusted software application (43) are fed to the monitoring apparatus (16), where they are filtered and prioritized. The filtered and prioritized service requests and/or target values are forwarded to the control unit with the output apparatus (49). Service requests and/or target values that do not comply with the rules are not forwarded by the monitoring apparatus (16).

FIG. 4A also shows a second arrangement (top right) of the monitoring apparatus (16) which is integrated into the second trusted computing device (44). The trusted software application (41) which is being executed on the trusted first computing device (40), and the untrusted software application (43) which is being executed on the untrusted computing device (42), each send service requests and/or target values to the monitoring apparatus (16), where they are filtered and prioritized. The filtered and prioritized service requests and/or target values are forwarded to the control unit with the output apparatus (49). Service requests and/or target values that do not comply with the rules are not forwarded by the monitoring apparatus (16).

FIG. 4A also shows a third arrangement (bottom left) of the monitoring apparatus (16) which is integrated into the second trusted computing device (44). The control unit with the output apparatus (49) is additionally integrated into the second trusted computing device (44) as part of this arrangement as well. The trusted software application (41) which is being executed on the trusted first computing device (40), and the untrusted software application (43) which is being executed on the untrusted computing device (42), each send service requests and/or target values to the monitoring apparatus (16), where they are filtered and prioritized. The filtered and prioritized service requests and/or target values are forwarded to the control unit with the output apparatus (49). Service requests and/or target values that do not comply with the rules are not forwarded by the monitoring apparatus (16).

FIG. 4A also shows a fourth arrangement (bottom right) of the monitoring apparatus (16) which is integrated into the computing device comprising anti-interference measures (45). The trusted software application (41) and the untrusted software application (43) are running on the computing device comprising anti-interference measures (45). The trusted software application (41) and the untrusted software application (43) each send service requests and/or target values to the monitoring apparatus (16), where they are filtered and prioritized. The filtered and prioritized service requests and/or target values are forwarded to the control unit with the output apparatus (49). Service requests and/or target values that do not comply with the rules are not forwarded by the monitoring apparatus (16).

FIG. 4B shows a fifth arrangement (left) of the monitoring apparatus (16) which is integrated into the second trusted computing device (44). The trusted software application (41) and the untrusted software application (43) are running on the computing device comprising anti-interference measures (45). The trusted software application (41) and the untrusted software application (43) each send service requests and/or target values to the monitoring apparatus (16), where they are filtered and prioritized. The filtered and prioritized service requests and/or target values are forwarded to the control unit with the output apparatus (49) which is located outside of the second trusted computing device (44). Service requests and/or target values that do not comply with the rules are not forwarded by the monitoring apparatus (16).

FIG. 4B shows a sixth arrangement (right) of the monitoring apparatus (16) which is integrated into the second trusted computing device (44). The trusted software application (41) and the untrusted software application (43) are running on the computing device comprising anti-interference measures (45). The trusted software application (41) and the untrusted software application (43) each send service requests and/or target values to the monitoring apparatus (16), where they are filtered and prioritized. The filtered and prioritized service requests and/or target values are forwarded to the control unit with the output apparatus (49) which is likewise integrated with the second trusted computing device (44). Service requests and/or target values that do not comply with the rules are not forwarded by the monitoring apparatus (16).

The presented embodiments of the method according to the present invention enable safe execution of untrusted software applications, the service requests and/or target values of which are implemented by a control unit with an output apparatus, in particular an actuator. This enables a high degree of flexibility for E/E architectures, in particular for vehicles.

A preferred application of the method according to the present invention is related to the control of a wiper of a vehicle. A service request, such as “control of angular position 20°” can be filtered by the monitoring apparatus and compared with rules. The rules can, for example, stipulate that angular positions greater than 10° can only be approached if the mode of the vehicle is “driving” and a state variable of the vehicle “hood closed” is present at the same time. Other rules are conceivable. too, in which case the rules can depend in particular on the modes.

1-8. (canceled)

9. A method for monitoring interfaces between a software application and a control unit, wherein the control unit controls an output apparatus, the method comprising:
checking at a service request and/or target value sent from the software application to the control unit based on rules, by a monitoring apparatus which is disposed such that the service request and/or target value can first be sent to the monitoring apparatus and from there to the control unit; and
sending the service request and/or target value from the monitoring apparatus to the control unit only when the check by the monitoring apparatus shows that the service request and/or target value is permissible.

10. The method according to claim 9, wherein the check by the monitoring apparatus is additionally carried out as a function of modes.

11. The method according to claim 10, wherein the monitoring apparatus includes a state machine that forms the modes based on input variables and/or state variables.

12. The method according to claim 8, wherein the monitoring apparatus additionally carries out a prioritization of a plurality of service requests and/or target values that the software application sends to the control unit.

13. The method according to claim 12, wherein every service request and/or target value sent by the software application to the control unit is checked by the monitoring apparatus.

14. An apparatus configured for monitoring interfaces between a software application and a control unit, wherein the control unit controls an output apparatus, the apparatus configured to:
check at a service request and/or target value sent from the software application to the control unit based on rules, by a monitoring apparatus which is disposed such that the service request and/or target value can first be sent to the monitoring apparatus and from there to the control unit; and
send the service request and/or target value from the monitoring apparatus to the control unit only when the check by the monitoring apparatus shows that the service request and/or target value is permissible.

15. A non-transitory electronic storage medium on which is stored a computer program for monitoring interfaces between a software application and a control unit, wherein the control unit controls an output apparatus, the computer program, when executed by a computer, causing the computer to perform the following steps:
checking at a service request and/or target value sent from the software application to the control unit based on rules, by a monitoring apparatus which is disposed such that the service request and/or target value can first be sent to the monitoring apparatus and from there to the control unit; and
sending the service request and/or target value from the monitoring apparatus to the control unit only when the check by the monitoring apparatus shows that the service request and/or target value is permissible.
